(19) United States
(12) Patent Application Publication
(10) Pub. No.: US 2016/0010976 A1
(43) Pub. Date: Jan. 14, 2016

(54) METHOD FOR THE MEASUREMENT OF AN OBJECT

(71) Applicant: SICK AG, Waldkirch/Breisgau (DE)

(72) Inventors: Achim NUBLING, Emmendingen (DE); Thorsten HARTER, Ortenberg (DE); Carsten EHRLER, Freiburg (DE)

(21) Appl. No.: 14/794,445

(22) Filed: Jul. 8, 2015

(30) Foreign Application Priority Data
Jul. 11, 2014 (DE) 10 2014 109 755.6

(51) Int. Cl. G01B 11/06; G01B 11/04

(52) U.S. Cl. CPC G01B 11/0691; G01B 11/04

(57) ABSTRACT

A method for the measurement of an object by means of a laser scanner is described, wherein the laser scanner detects at least a first type of measurement values and a second type of measurement values. In this respect, a resultant value is calculated in that measurement values of the first type are weighted by measurement values of the second type.

The present invention relates to a method for the measurement of an object by means of a laser scanner, wherein the laser scanner detects at least a first type of measurement values and a second type of measurement value.

Laser scanners are used in a plethora of applications for the measurement of objects, for example in order to determine the presence, the position, the length, the width and/or the height or the spacing of an object. Laser scanners are in this respect in particular used in the automation technology in order to, e.g. measure packages or letters transported on conveyor belts or on tray sorters, wherein a sorting of the packages or of the letters is, for example carried out on the basis of their height.

Typically, e.g. mixed pixel filters or median filters are used in order to filter the measurement values detected by the laser scanner. Following the filtering, the height of an object can, for example be calculated from the filtered measurement values of the laser scanner.

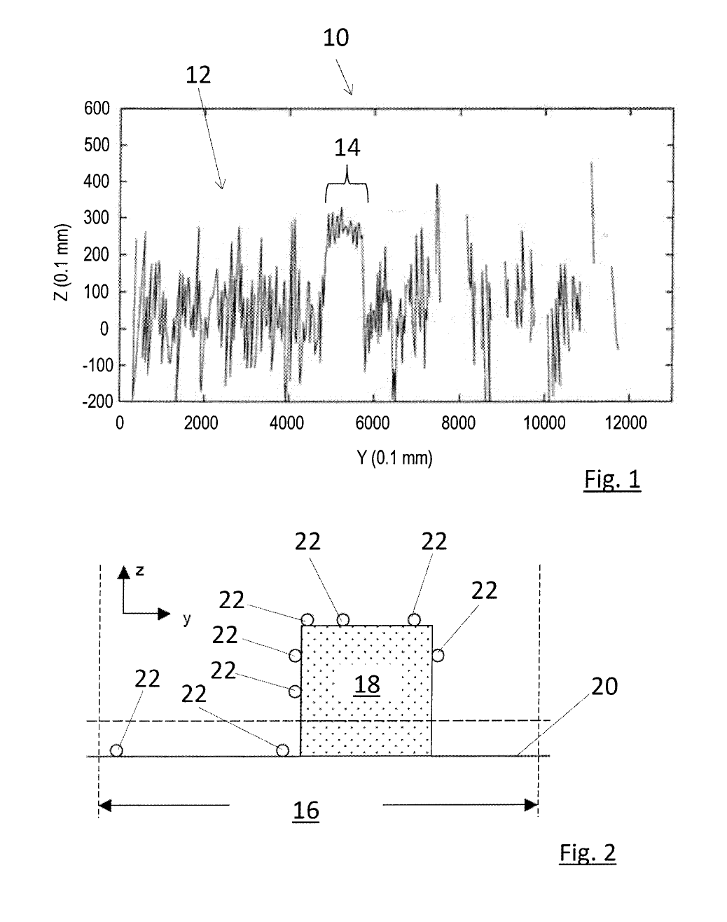

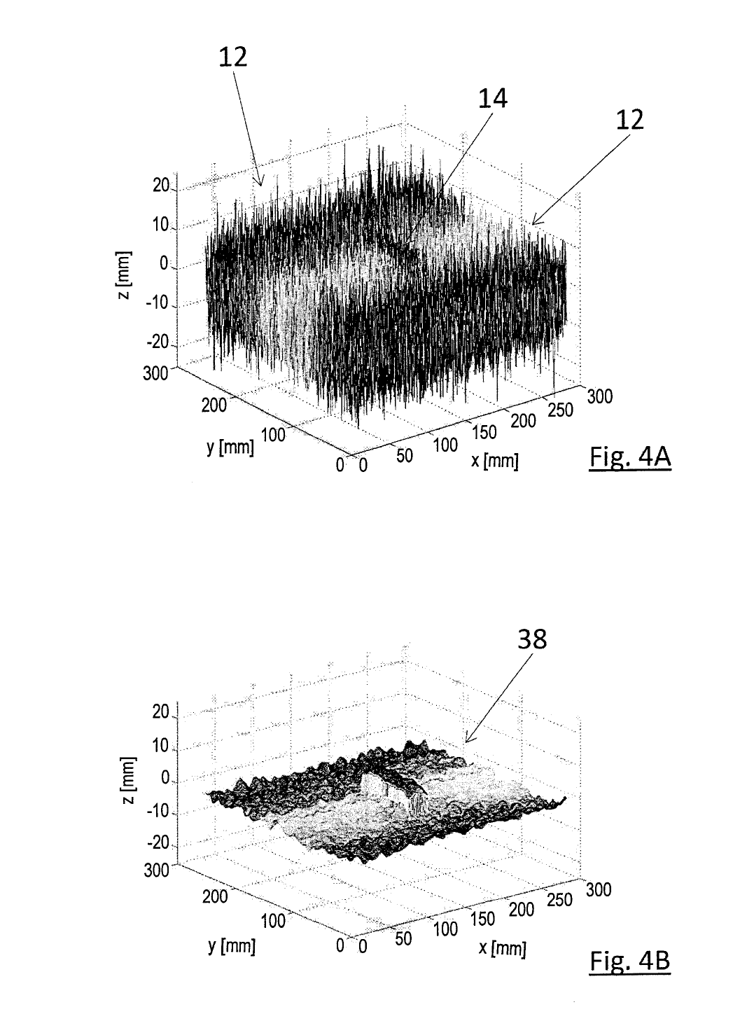

However, the measurement values of a laser scanner are always subject to a certain noise and to a certain measurement inaccuracy (see FIG. 1 and FIG. 4A) such that in particular flat objects can only be detected and/or measured with great difficulty. This is in particular the case when the static noise of the measurement values of the laser scanner is greater than the minimum object height to be measured. Then flat objects cannot be measured in a reliable manner and thus not in a manner relevant to calibration, regarding which the filtering described in the foregoing also does not change anything.

For this reason, it is the object of the invention to provide a method for the measurement of an object by means of a laser scanner, which method allows a reliable and stable measurement also of flat objects.

This object is satisfied in accordance with the invention by the method in accordance with claim 1 and in particular in that a resultant value is calculated, in that measurement values of the first type are weighted by measurement values of the second type.

In this respect, the invention is based on the recognition that the measurement values of the first type can be improved when they are used in calculations with the measurement values of the second type, and in this way are weighted by the measurement values of the second type. The resultant value arising with the weighting is a value of the first type; this means the resultant value has the same unit (e.g. mm) as the measurement values of the first type. The resultant value is thus an improved measurement values of the first type, by means of which, for example, the height of an object can be indicated with an improved accuracy and/or with a reduced noise.

The laser scanner generally comprises a light transmitter for the transmission of light signals, a light deflection unit (formed, for example, by means of a rotating mirror) for the periodic deflection of the light signals transmitted into a detection region by the light transmitter, and a light receiver for the reception of light thrown back from an object present in the detection region. By means of the light signal, a line-shaped (one-dimensional) or a rectangular (two-dimensional) region can be scanned by means of the laser scanner. The scanned region can in this respect be divided into different measurement points, so-called pixels, wherein at least one measurement value of the first type and one measurement value of the second type are detected for each measurement point.

A line-shaped region can also be scanned by means of the light signal, wherein the object to be measured is, e.g. moved by a conveyor belt, e.g. perpendicular to the scanned line, in order to measure the object as a whole.

Following the detection of the measurement values of the first type and of the second type, the measurement values of the first type are weighted by the measurement values of the second type in order to calculate the resultant value. The resultant value can in each case be associated with precisely one measurement point or also with a plurality of measurement points.

Due to the weighting of the measurement values of the first type by the measurement values of the second type, greatly improved resultant values in comparison with the measurement values of the first type are generated.

Advantageous embodiments of the invention are described in the description, in the drawings and in the dependent claims.

The measurement values of the first type preferably indicate a distance from the laser scanner. The distance is calculated by the laser scanner, e.g. from a time of flight measurement of a light pulse with regard to the respective measurement point or by means of a phase shift of a modulated light signal, said phase shift being dependent on a time of flight. The association of the measured distance with a measurement point in this respect takes place by means of the angle at which the laser scanner has transmitted the respective light signal. By means of a known distance, e.g. of the conveyor belt, this means of the background of the object, the height of the object can then, for example be determined. Accordingly, the measurement values of the first type can also be height measurement values.

The measurement values of the second type furthermore preferably indicate a remission. The remission describes which portion of a light signal is thrown back from a certain measurement point towards the laser scanner. This portion can vary, for example on the basis of the surface property of the object and/or on the basis of its color.

Due to the measurement of the object using distance values and remission values, the object is measured in a multimodal manner. In this respect, a plurality of measurement points can be generated for the object which, for example have different remission values for inhomogeneous objects. The distance values can also be different for different measurement points of the object, as the distance values fluctuate by the actual distance of the respective measurement point from the laser scanner and by the inaccuracy of the laser scanner.

Due to the circumstance that the object typically has a remission behavior which is different from the remission behavior of the background (such as of a conveyor belt), the resultant value, which is in turn a distance value, can be improved with respect to the measured distance value by means of a weighting of the distance values by the remission values. The accuracy of the laser scanner is increased by means of the weighting entered into the resultant values, whereby in particular objects which are particularly flat and thin can also be clearly distinguished from the background and can in this way be measured.

In accordance with an advantageous embodiment of the invention, the measurement values of the first type and/or the measurement values of the second type are weighted in dependence on the respective spacing to a position of the resultant value. In this way, measurement values of the first type and/or of the second type can influence the resultant value to a greater extent, the closer they are to the to the measurement point with which the resultant value is associated.

For the calculation of the resultant value, preferably only measurement values are considered whose positions at most have a predefined spacing to the resultant value. The resultant value is therefore only calculated on the basis of a predefined number of measurement points using measurement values from a vicinity of a measurement point associated with the resultant value. For example, the vicinity can have a size of 3×3, 9×9 or 11×11 measurement points (this means pixels), with the position of the resultant value in each case lying in the center of the vicinity. The calculation demand in effort for the calculation of the resultant value can be adapted through adaptation of the size of the vicinity to the available computing power, while taking into account the required speed of calculation and the required accuracy.

In accordance with a further advantageous embodiment, the resultant value is calculated in the manner of a bilateral filter on the use of the equation

$$F [ {d}_{i} ] = \frac{1}{{W}_{i}} {\sum }_{j ∈ S} {G}_{{σ}_{d}} ( ‖ {p}_{i} - {p}_{j} ‖ ) {G}_{{σ}_{r}} ( \vert {r}_{i} - {r}_{j} \vert ) {d}_{j} ,$$

wherein
F[dᵢ] is the resultant value,

dᵢ are the measurement values of the first type at the position of the resultant value,
Wᵢ is the sum of the filter coefficients,
S is the vicinity about the position of the resultant value,
G_{σ}_{_{d}} is the Gaussian function having standard deviation σ_{d},
pᵢ is the position of the resultant value,
pⱼ is the position of a pixel in the vicinity of the position of the resultant value,
G_{σ}_{ᵣ} is the Gaussian function having standard deviation σᵣ,
rᵢ are the measurement values of the second type at the position of the resultant value,
rᵢ are measurement values of the second type in the vicinity of the position of the resultant value, and
dᵢ are measurement values of the first type in the vicinity of the position of the resultant value.

In accordance with the equation, an iteration over all measurement points of the vicinity S is carried out for the calculation of the resultant value F[dᵢ] associated with the measurement values of the first type dᵢ, wherein the normalized spatial spacing of the respective measurement point in the vicinity of the position of the resultant value is represented by means of the term ||pᵢ-pⱼ||. The normalized spatial spacing serves as an input value of the Gaussian function and/or of the Gaussian distribution having standard deviation σ_{d} (G_{σ}_{_{d}}).

The amount of the difference of the remission values at the respective measurement point and of the remission at the position of the measurement point which is associated with the resultant value is given by means of the term |rᵢ-rⱼ|. This value serves as an input value of the Gaussian function and/or of the Gaussian distribution having standard deviation σᵣ (G_{σ}_{ᵣ}).

The results of the Gaussian functions having standard deviation σ_{d} and σᵣ are subsequently multiplied by the respective measurement values of the first type (dⱼ), this means by the measured distance measurement values in the spatial vicinity of the position of the resultant value. The value obtained in this way is determined for all measurement points in the vicinity of the position of the resultant value, wherein these values are added up and are divided by the sum of the filter coefficients (Wᵢ) in order to obtain the resultant value F[d_{i].}

Typically, a vicinity S of equal size, for example a 11×11 vicinity, is in each case used for the calculation of a plurality of resultant values. In this case, the values of the term Gσ_{d} (||pᵢ-pⱼ||) are constant, as the spacings of the respective measurement values to the spatial position associated with the resultant value are constant. For this reason, these values do not have to be repeatedly calculated, but can rather be generated once and stored, for example in a look-up table.

In contrast to this, the term Gσᵣ (|rᵢ-rⱼ|) is dependent on the respective measurement values of the second type, this means, for example on the measured remission values which can fluctuate in dependence on the measured object. For this reason, this term provides different results for different measurement values of the second type. This means that the term for the remission is recalculated for each resultant value, whereby the resultant value is based on an adaptive filtering.

Alternatively, a Laplace distribution and/or a Laplace function can also be used for at least one of the Gaussian functions Gσ_{d}, Gσᵣ. The combination of a Gaussian function and a Laplace function is likewise possible. Alternatively, further probability distributions can also be used instead of the Gaussian function or the Laplace function.

The filtering of the measurement values can in particular be adapted to the respective application by means of the variation of the parameters σ_{d}, σᵣ of the respective Gaussian function Gσ_{d}, Gσᵣ in order to obtain optimized resultant values.

In accordance with a further advantageous embodiment, the resultant value is also calculated on the basis of further measurement values, the further measurement values indicating, e.g. a color value, and/or a gray scale value and/or an infrared value. The resultant value can be further improved through the consideration of additional measurement values.

For this purpose, the laser scanner can be configured to detect a color value and/or a gray scale value and/or an infrared value. The use of the color value and/or of the gray scale value and/or of the infrared value instead of the remission value can also take place. Additional measurement values can in particular be integrated into the equation explained above in the same manner as the remission values, wherein one further Gaussian function can in particular be multiplied by the respective measurement values of the first type for the gray scale values.

The calculation of the resultant value can, for example take place on an additional consideration of a gray scale value in that the respective measurement values of the first type is, on formation of the sum over all elements of the vicinity S, additionally multiplied by a Gaussian function having a standard deviation which corresponds to the standard deviation of the gray scale values. The input value for the Gaussian function is the amount of the difference between the gray scale value at the position of the resultant value and the gray scale value at the respective position of a measurement point in the vicinity.

In accordance with a further advantageous embodiment, the method is carried out in an iterative manner, wherein the measurement values of the first type is replaced by the resultant value at the position of the resultant value. The resultant value of the preceding iteration thus serves as an input value and/or as a measurement value of the first type for the next iteration. In this way, the accuracy of the resultant value can be further increased. In particular, e.g. 2, 4 or 8 iterations can be carried out.

The method is particularly preferably repeated for each measurement point of the laser scanner. This means that a resultant value is calculated for each measurement point, wherein the measurement of the object can take place in a much more precise manner on the basis of the calculated resultant values.

In accordance with a further advantageous embodiment, the resultant value is calculated by means of an FPGA (Field Programmable Gate Array) or a GPU (Graphics Processing Unit). In particular a GPU is particularly optimized for the application of filter functions and in this way enables a fast calculation of the resultant value.

The invention furthermore comprises a laser scanner for the measurement of an object in a detection region, comprising a light transmitter for the transmission of light signals, a light deflection unit for the periodic deflection of the light signals transmitted into the detection region by the light transmitter, a light receiver for the reception of light thrown back from the object present in the detection region, wherein the laser scanner is configured to detect at least a first type of measurement values and a second type of measurement values of the object and wherein the laser scanner comprises an evaluation unit that is configured to calculate a resultant value in that measurement values of the first type are weighted by measurement values of the second type.

The evaluation unit can in this respect be an FPGA, a GPU or a control processor connected to the laser scanner.

The statements made with respect to the method in accordance with the invention are accordingly also true for the laser scanner in accordance with the invention.

The invention will be described in the following purely by way of example with reference to a possible embodiment and by means of the enclosed drawings. There are shown:

FIG. 1 a measurement signal of a laser scanner of the prior art;

FIG. 2 an object with measurement points for the measurement of the object;

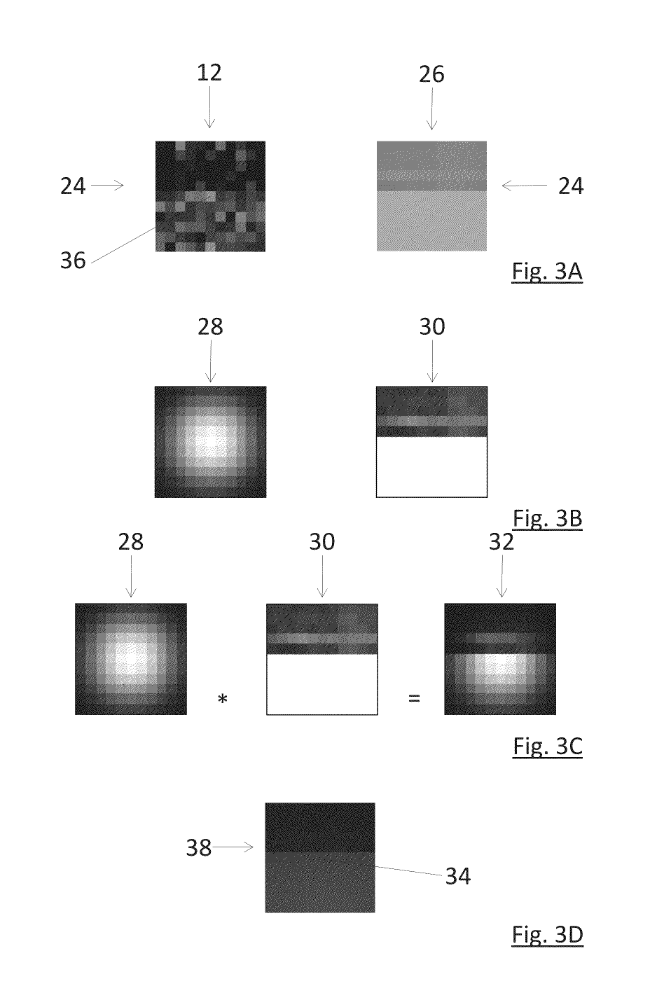

FIG. 3A on the left-hand side measured height values and on the right-hand side measured remission values in a 11×11 vicinity;

FIG. 3B a filter in accordance with the function Gσ_{d} (||pᵢ-pⱼ||) (left-hand side of the Figure) and a filter in accordance with the function Gσᵣ (|rᵢ-rⱼ|) (right-hand side of the Figure);

FIG. 3C the multiplication of the filters shown in FIG. 3B and their result;

FIG. 3D the application of the filter calculated in FIG. 3C to the height values shown in FIG. 3A and the resultant values resulting therefrom;

FIG. 4A unfiltered measurement values of a laser scanner in accordance with the prior art; and

FIG. 4B the measurement values of FIG. 4A which have been filtered by means of the filter of FIG. 3C generated for the respective measurement point.

FIG. 1 shows a measurement 10 with height measurement values 12 from a measurement of a laser scanner (not shown) drawn on in the direction of the ordinates. The height measurement values 12 extend over an elongate region of 1,200 mm, which is drawn on the abscissa. The height measurement values 12 are calculated from distance measurement values (from the laser pulse time of flight) recorded by the laser scanner, wherein the spacing of the laser scanner to a background of an object is known. The background is, e.g. a conveyor belt 20 (FIG. 2).

Height measurement values 14 of an object 18 (FIG. 2) are present in an abscissa region of between approximately 400 and 600 mm. The remaining height measurement values 12 do not originate from the object 18, but rather from the conveyor belt 20 and should show the measurement values zero in the ideal case. However, the illustrated real height measurement values 12 have a statistic noise which leads to less precise height measurement values 12.

FIG. 2 shows a detection region 16 of a laser scanner in which an object 18, for example a postal package, is present on a conveyor belt 20, with the conveyor belt 20 forming the background of the object 18. In FIG. 2, a plurality of measurement points 22 are illustrated with which the object 18 is measured.

Just as FIG. 1, the left image of FIG. 3A also shows height measurement values 12 of a laser scanner in accordance with the prior art, wherein a vicinity 24 having 11×11 pixels is illustrated, with an edge of the object 18 extending within the vicinity. Each pixel represents a measurement point 22. In this respect, brighter pixels indicate a larger measured height with respect to the background.

The vicinity 24 is again illustrated on the right-hand side of FIG. 3A; in this instance, remission measurement values 26 recorded by the laser scanner are shown. Having regard to the remission measurement values 26, brighter pixels indicate a stronger remission.

In FIG. 3B, the function Gσ_{d} (||pᵢ-pⱼ||)and the function Gσᵣ (|rᵢ-rⱼ|) at the left-hand side and at the right-hand side respectively are illustrated as filters of the size 11×11. The left-hand filter in this respect represents a constant filter portion 28 which follows a Gaussian function and which accordingly has the highest values in the center. Corresponding to the illustration of the height measurement values 12 and of the remission measurement values 26, brighter pixels indicate higher values.

The right-hand filter represents an adaptive filter portion 30 at which each of the 121 (11×11) filter points are determined in that the respective remission measurement values 26 is subtracted from the central remission measurement values 26 and the result of the subtraction serves as an input value of a Gaussian function. Accordingly, the lower part of the adaptive filter portion 30 only shows white pixels, as the remission measurement values 26 in this region are all identical and the subtraction of these remission measurement values 26 from the central remission measurement values 26 in this way results in zero. The value of the Gaussian function for the value zero is at a maximum; consequently these values are illustrated by means of white pixels.

FIG. 3C shows a filter 32 resulting from a multiplication of the constant filter portion 28 and the adaptive filter portion 30.

On the carrying out of the method, the resulting filter 32 is applied to the vicinity 24 in order to obtain a resultant value 34 for the central height measurement values 36 (FIG. 3A). In order to obtain a resultant value for all height measurement values 12 of the vicinity 24, the method is applied to each height measurement values 12 of the vicinity 24, wherein the vicinity 24 is displaced for each height measurement values 12 and a new adaptive filter portion 30 is also calculated for each height measurement values 12.

After application of the method to all height measurement values 12 of the vicinity 24, this means after carrying out the method 121 times, the final result 38 illustrated in FIG. 3D results. In the final result 38, the difference in height between the object present in the lower part and the background present in the upper part can be clearly recognized on the basis of the difference in brightness. The noise of the measurement values has clearly decreased.

A further illustration of the functional principle of the method is shown in the FIG. 4A and the FIG. 4B. FIG. 4A shows noisy height measurement values 12 of a laser scanner, wherein height measurement values 12 of an object 18 are also detected. The illustration of the height measurement values 12 in this respect takes place in a manner corresponding to FIG. 1 with the difference that a two-dimensional field of height measurement values 12 is illustrated. The remission measurement values 26 associated with the height measurement values 12 of FIG. 4A are not shown.

After carrying out of the method for all height measurement values 12, this means after calculation of a resultant value 34 for each height measurement values 12, the final result 38 shown in FIG. 4B results, in which final result the position and the height of the object can be clearly recognized.

During the operation of the laser scanner, the method can be applied to all height measurement values 12 which are detected by the laser scanner. The laser scanner can then output a resultant value 34 for each height measurement values 12, instead of the height measurement values 12, on the basis of which resultant value a process control of an industrial plant can, for example take place.

### LIST OF REFERENCE NUMERALS

10 measurement
12 height measurement values signal
14 height measurement values in the region of an object
16 detection region
18 object
20 conveyor belt
22 measurement point
24 vicinity
26 remission measurement values
28 constant filter portion
30 adaptive filter portion
32 resulting filter
34 resultant value
36 central height measurement value
38 final result

1. A method for the measurement of an object by means of a laser scanner, wherein the laser scanner detects at least a first type of measurement values and a second type of measurement values, wherein
a resultant value is calculated in that measurement values of the first type are weighted by measurement values of the second type.

2. The method in accordance with claim 1,
wherein the measurement values of the first type indicate a distance from the laser scanner.

3. The method in accordance with claim 1,
wherein the measurement values of the second type indicate a remission.

4. The method in accordance with claim 1,
wherein the measurement values of the first type and/or the measurement values of the second type are weighted in dependence on the respective spacing to a position of the resultant value.

5. The method in accordance with claim 1,
wherein, for the calculation of the resultant value, only measurement values are considered whose positions at most have a predefined spacing to the position of the resultant value.

6. The method in accordance with claim 1,
wherein the resultant value is calculated in the manner of a bilateral filter on the use of the equation
$$F [ {d}_{i} ] = \frac{1}{{W}_{i}} {\sum }_{j ∈ S} {G}_{{σ}_{d}} ( ‖ {p}_{i} - {p}_{j} ‖ ) {G}_{{σ}_{r}} ( \vert {r}_{i} - {r}_{j} \vert ) {d}_{j} ,$$
wherein
F[dᵢ] is the resultant value,
dᵢ are the measurement values of the first type at the position of the resultant value,
Wᵢ is the sum of the filter coefficients,
S is the vicinity about the position of the resultant value,
G_{σ}_{_{d}} is the Gaussian function having standard deviation σ_{d},
pᵢ is the position of the resultant value,
pⱼ is the position of a pixel in the vicinity of the position of the resultant value,
G_{σ}_{ᵣ} is the Gaussian function having standard deviation σᵣ,
rᵢ are the measurement values of the second type at the position of the resultant value,
rⱼ are measurement values of the second type in the vicinity of the position of the resultant value, and
dⱼ are measurement values of the first type in the vicinity of the position of the resultant value.

7. The method in accordance with claim 1,
wherein the resultant value is also calculated on the basis of further measurement values, the further measurement values indicating a color value, and/or a gray scale value and/or an infrared value.

8. The method in accordance with claim 1,
wherein the method is carried out in an iterative manner, wherein the measurement values of the first type is replaced by the resultant value F[dᵢ] at the position of the resultant value.

9. The method in accordance with claim 1,
wherein the method is repeated for each measurement point of the laser scanner.

10. The method in accordance with claim 1,
wherein the resultant value is calculated by means of an FPGA (Field Programmable Gate Array) or a GPU (Graphics Processing Unit).

11. A laser scanner for the measurement of an object in a detection region, comprising a light transmitter for the transmission of light signals, a light deflection unit for the deflection of the light signals transmitted into the detection region by the light transmitter, a light receiver for the reception of light thrown back from an object present in the detection region, wherein the laser scanner is configured to detect at least a first type of measurement values and a second type of measurement values of the object and wherein the laser scanner comprises an evaluation unit that is configured to calculate a resultant value in that measurement values of the first type are weighted by measurement values of the second type.
